(19) United States
(12) Patent Application Publication
(10) Pub. No.: US 2026/0188785 A1
(43) Pub. Date: Jul. 2, 2026

(54) BATTERY PACK THERMAL RUNAWAY (TR) PROPAGATION MITIGATION SYSTEM

(71) Applicant: Wisk Aero LLC, Mountain View, CA (US)

(72) Inventors: Anthony Courville, Mountain View, CA (US); Jordan Mathews, Denver, CO (US); Sam Nepia, Christchurch (NZ); Scott Thawley, Las Vegas, NV (US)

(73) Assignee: Wisk Aero LLC, Mountain View, CA (US)

(21) Appl. No.: 19/431,800

(22) Filed: Dec. 23, 2025

Related U.S. Application Data
(60) Provisional application No. 63/740,545, filed on Dec. 31, 2024.
(60) Provisional application No. 63/770,289, filed on Mar. 11, 2025.

(51) Int. Cl. H01M 10/6568; H01M 10/613; H01M 10/625; H01M 10/633; H01M 50/627; H01M 50/673

(52) U.S. Cl. CPC H01M 10/6568; H01M 10/625; H01M 10/633; H01M 50/627; H01M 50/673; H01M 10/613

(57) ABSTRACT

A thermal runaway (TR) propagation mitigation system includes a plurality of battery modules, and an onboard recirculation system coupled to the plurality of battery modules. The onboard recirculation system includes a primary valve for transitioning the onboard recirculation system between a closed loop configuration and an open loop configuration, a cooling fluid container storing cooling fluid provided to the TR propagation mitigation system when the onboard recirculation system is in the closed loop configuration, and a pump for flowing the cooling fluid through the TR propagation mitigation system when the onboard recirculation system is in the closed loop configuration. A method of cooling a plurality of battery modules includes transitioning a primary valve between an open configuration and a closed configuration, distributing cooling fluid through a common fluid line to the plurality of battery modules in a battery pack when the primary valve is in the closed configuration.

### CROSS-RELATED APPLICATIONS

This application claims priority to Provisional Patent Application No. 63/740,545 , “Battery Pack Thermal Runway (Tr) Propagation Mitigation System,” and further claims priority to Provisional Patent Application No. 63/770,289 , “Battery Pack Thermal Runway (Tr) Propagation Mitigation System” which are incorporated herein by reference in their entirety for all purposes.

### BACKGROUND OF THE INVENTION

Cooling is one of many considerations for every aerospace application and solutions are uniquely designed to meet the highly specific requirements of each system. Cooling helps maintain optimal conditions and may be used to extend the lifespan of various pieces of equipment. Liquid cooling systems are particularly useful where precise temperature management is of the utmost importance. Liquid systems may be used to stabilize equipment temperatures, thereby reducing thermal fluctuations and temperature variations.

### BRIEF SUMMARY OF THE INVENTION

Systems and methods of the present disclosure relate to cooling systems, in particular, cooling systems for aircraft.

Systems and methods of the present disclosure include an onboard liquid cooling system for actively redistributing heat from a thermal runaway (TR) module toward a bulk thermal mass of a battery system. The liquid cooling system as described herein may be applied to any modular battery system where the TR is stopped from module-to-module propagation. Various embodiments of the present disclosure may be implemented into lightweight applications where there are no active liquid cooling systems such as chillers, or the like, to provide a cooling source.

According to one embodiment, a thermal runaway (TR) propagation mitigation system includes a plurality of battery modules and an onboard recirculation system coupled to the plurality of battery modules. The onboard recirculation system includes a primary valve for transitioning the onboard recirculation system between a closed loop configuration and an open loop configuration, a cooling fluid container storing cooling fluid provided to the TR propagation mitigation system when the onboard recirculation system is in the closed loop configuration, and a pump for flowing the cooling fluid through the TR propagation mitigation system when the onboard recirculation system is in the closed loop configuration.

The system may include various optional embodiments. The system may further include a ground station port operable to flow additional cooling fluid through the TR propagation mitigation system when the onboard recirculation system is in the open loop configuration. Each of the plurality of battery modules may include a secondary valve where each of the secondary valves is operable to stop flow of the cooling fluid to, in response to a thermal runaway event in, a respective battery module. The plurality of battery modules may be coupled to the TR propagation mitigation system in parallel. The cooling fluid may only flow from the cooling fluid container when the onboard recirculation system is in the closed loop configuration. The onboard recirculation system may further include a common fluid line fluidly coupled to each of the plurality of battery modules for distributing the cooling fluid to each of the plurality of battery modules. The system may further include a sensor configured to detect a change in temperature indicative of a thermal runaway event in at least one battery module of the plurality of battery modules. The primary valve may be a solenoid valve.

According to another embodiment, an aerial vehicle may include one or more of the TR propagation mitigation systems described in detail above. The aerial vehicle may be an eVTOL vehicle.

According to yet another embodiment, a method of cooling a plurality of battery modules includes transitioning a primary valve between an open configuration and a closed configuration, distributing cooling fluid through a common fluid line to the plurality of battery modules in a battery pack when the primary valve is in the closed configuration, and detecting a thermal runaway event in at least one of the plurality of battery modules. The method further includes distributing additional cooling fluid from a cooling fluid container through the common fluid line to the plurality of battery modules.

The method may include various optional embodiments. The method may further include distributing supplementary cooling fluid through the common fluid line via a ground station port when the primary valve is in the open configuration. The method may further include, in response to detecting the thermal runaway event, closing a secondary valve coupled the at least one of the plurality of battery modules to stop flow of the cooling fluid. The additional cooling fluid may flow from the cooling fluid container when the primary valve is in the closed configuration. The plurality of battery modules may be coupled to the common fluid line in parallel. The battery pack may be installed in an aerial vehicle. The aerial vehicle may be an eVTOL vehicle. The primary valve is a solenoid valve. The method may further include detecting the thermal runaway event in the at least one of the plurality of battery modules via a sensor configured to detect a change in temperature indicative of the thermal runaway event. The method may further include detecting an end of the thermal runaway event in the at least one of the plurality of battery modules via the sensor and stopping flow of the cooling fluid from the cooling fluid container through the common fluid line to the plurality of battery modules, in response to the end of the thermal runaway event.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a simplified, isometric view of an example battery pack, according to at least one example.

FIG. 1B illustrates an exploded, isometric view of the battery pack of FIG. 1A, according to at least one example.

FIG. 2A is a block diagram of a cooling system, according to various embodiments of the present disclosure.

FIG. 2B is a block diagram of a cooling system, according to various embodiments of the present disclosure.

FIG. 3 is a flowchart of a method of operating a TR propagation mitigation system, according to various embodiments of the present disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

The figures and the following description relate to various embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

As systems use more battery cells to increase their energy density, the associated thermal runaways will release more heat such that traditional insulation configurations will not be capable of adequately distributing the heat. Accordingly, there is a need in the art for improved heat distribution and cooling systems.

Systems and methods of the present disclosure include an onboard liquid cooling system for actively redistributing heat from a TR module toward a bulk thermal mass of a battery system. Embodiments of the present disclosure provide TR propagation mitigation. Systems and methods as described herein may reuse the liquid cooling system components, thereby providing an onboard active cooling system while minimizing a number of additional parts and weight added to the system.

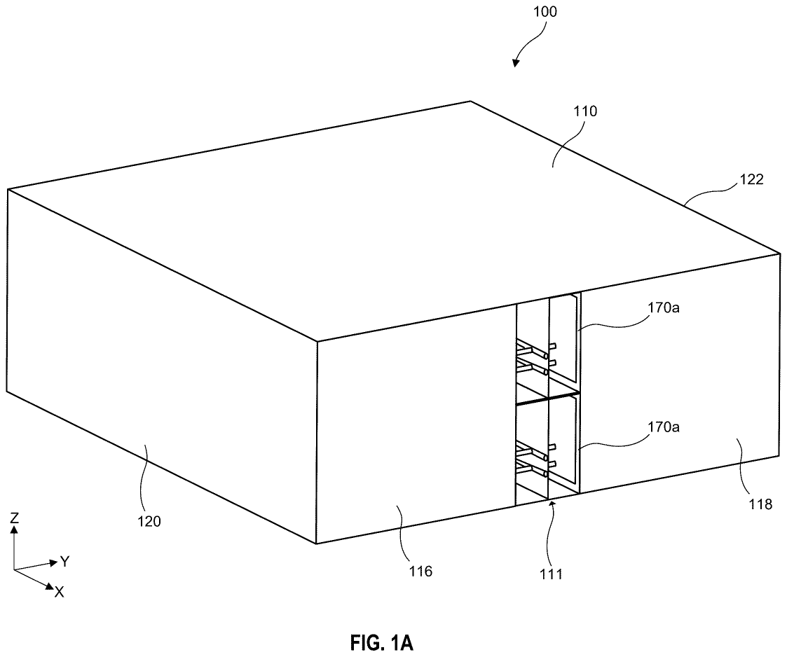

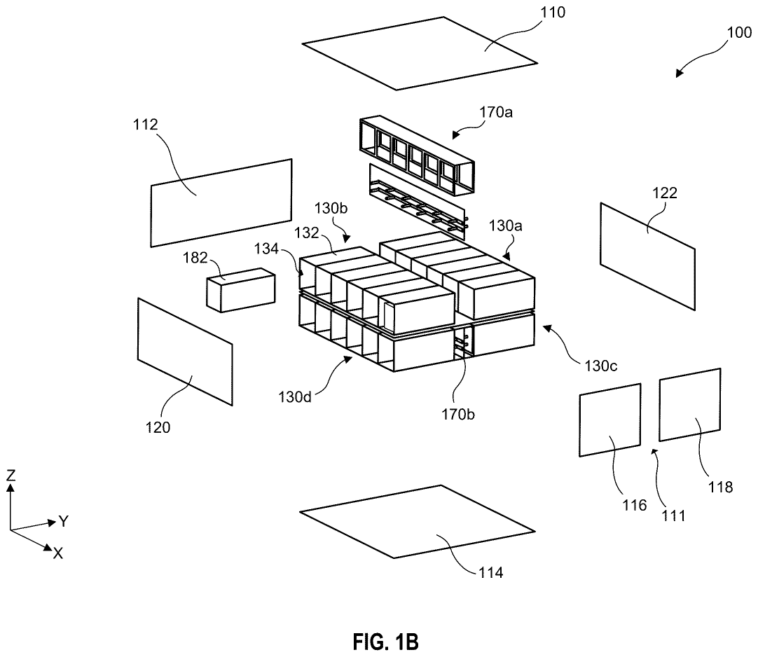

FIGS. 1A and 1B depict an example battery pack 100. With specific reference to FIG. 1B, the battery pack 100 can define an enclosure formed by a first panel 110, a second panel 112, a third panel 114, a fourth panel 116, a fifth panel 118, a first sidewall 120, and a second sidewall 122. The panels 112, 114, 116, 118 may be coupled together (e.g., via welding, brazing, soldering, gluing, fastening, or the like) to define an interior volume. The panels 110, 112, 114, 116, 118 and sidewalls 120, 122 may define the enclosure to have a substantially cuboid structure, however, in other embodiments, the enclosure may have other shapes, such as being pyramid, spherical, or the like. It should be understood that, for the sake of visual clarity, the battery pack 100 may include additional components not depicted in FIGS. 1A and 1B.

The interior volume may house internal components of the battery pack 100, such as sets of battery modules 132. For example, the enclosure may house a first module row 130a of battery modules 132, a second module row 130b of battery modules 132, a third module row 130c of battery modules 132, and a fourth module row 130d of battery modules 132. Each battery module 132 may define a battery volume 134 sized and shaped to house a grouping 182 of battery cells such that each module row 130a, 130b, 130c, 130d. Each grouping 182 of battery cells can include battery cells grouped together in a stacked configuration, wound configuration, or the like. Although each module row 130a, 130b, 130c, 130d is depicted as including six battery modules 132, in other embodiments, one or more of the module rows can have more or less than six battery modules, such as four battery modules, five battery modules, seven battery modules, eight battery modules, or the like. In other embodiments, the battery modules of each module row may not be oriented in a linear row but, instead, may be oriented as a set of battery modules in a set of non-linear orientation.

The battery pack 100 can include a first venting system 170a positioned between the module rows 130a, 130b and a second venting system 170b positioned between the module rows 130c, 130d. The battery modules 132 of each of the module rows 130a, 130b, 130c, 130d may be coupled to the corresponding venting system 170a, 170b (e.g., via welding, brazing, soldering, gluing, fastening, or the like) such that an airtight seal is formed between each battery module 132 and the corresponding venting system 170a, 170b. The battery modules 132 may be coupled directly with the corresponding venting system 170a, 170b to form this airtight seal. However, in other embodiments, one or more intervening component(s) (e.g., including a gasket, seal ring, or the like) may be positioned between the battery module and the corresponding venting system to form the airtight seal. The first venting system 170a can be in fluid communication with the module rows 130a, 130b through the airtight seal such that effluent discharge may flow through the first venting system 170a and an exit opening 111 defined between the panels 116, 118 to exterior of the battery pack 100. The second venting system 170b can be in fluid communication with the module rows 130c, 130d through the airtight seal such that effluent discharge may flow through the second venting system 170b and the exit opening 111 defined between the panels 116, 118 to exterior of the battery pack 100.

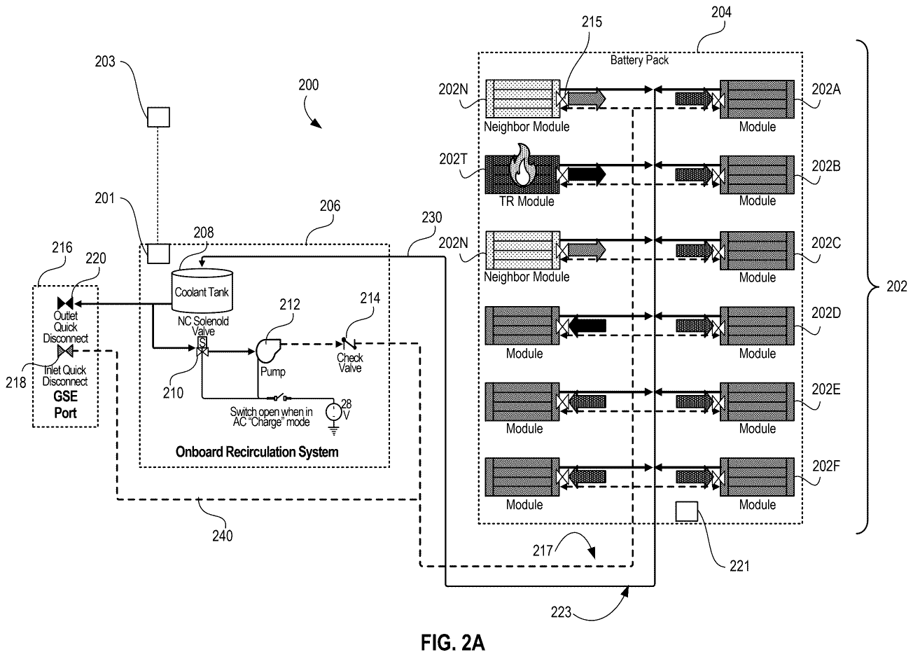

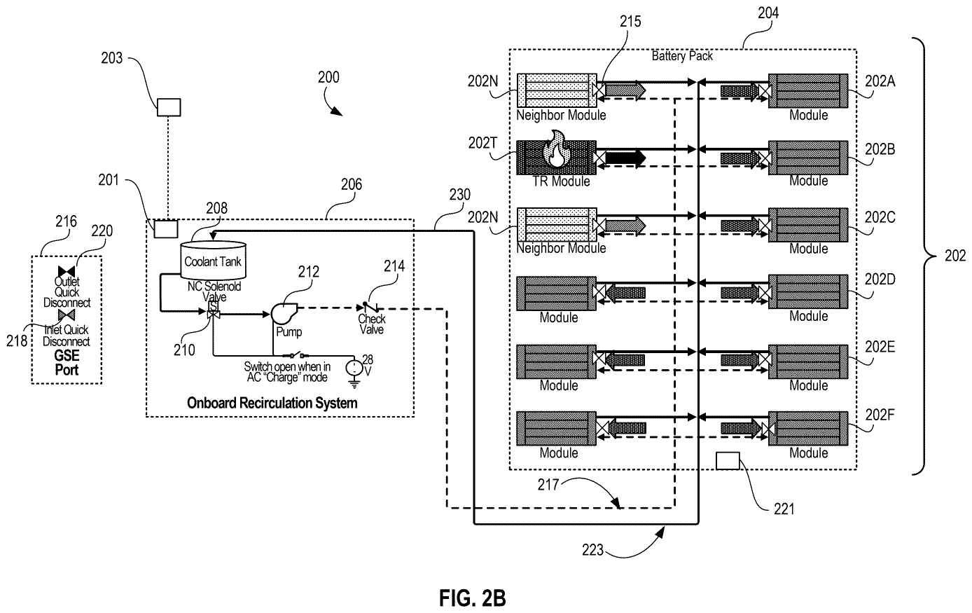

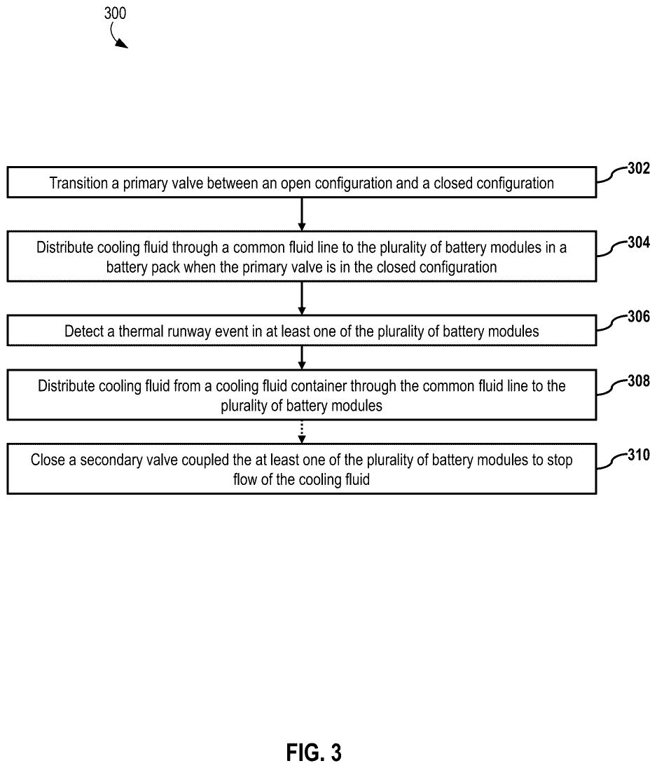

FIG. 2A is a block diagram of a cooling system, according to various embodiments of the present disclosure. The cooling system is referred to herein as a thermal runaway (TR) propagation mitigation system 200. The TR propagation mitigation system 200 is suitable for use in a battery-powered vehicle, such as an electric car or aircraft. In various embodiments, the TR propagation mitigation system 200 as described herein may be used in an aerial vehicle, and, in some embodiments, in an electric vertical take-off and landing (eVTOL) vehicle. The TR propagation mitigation system 200 includes an onboard recirculation system 206 that transitions between an open loop configuration (as shown in FIG. 2A) and a closed loop configuration (as shown in FIG. 2B). According to various embodiments, a flight control system 203 may include a flight controller for detecting the connection between the ground supply and determining that the TR propagation mitigation system 200 is in an open loop configuration or a closed loop configuration and causes the TR propagation mitigation system 200 to transition between configurations. Various embodiments of the present disclosure, such as operations of process 300 described in detail below with respect to FIG. 3, are performed by one or more processors 201. As shown, the one or more processors 201 may be part of the onboard recirculation system 206. In other embodiments, the one or more processors 201 may be part of the TR propagation mitigation system 200 or a device including the TR propagation mitigation system 200, such as an aerial vehicle or the like. The one or more processors 201 may part of and/or coupled to the flight control system 203 that receives signals, processes signals, and causes various operations to be performed.

In various embodiments, the TR propagation mitigation system 200 includes a plurality of battery modules 202A-202F, etc., (collectively, battery modules 202) of a battery pack 204. In various embodiments, the battery pack 204 is coupled to, or otherwise suitable for use with, an onboard recirculation system 206. In some embodiments, more than one battery pack may be coupled to one onboard recirculation system 206. In yet further embodiments, a plurality of battery modules 202 may be coupled to one onboard recirculation system 206. The onboard recirculation system 206 includes a primary valve 210 for transitioning the onboard recirculation system 206 between a closed loop configuration and an open loop configuration. For example, transitioning the primary valve 210 between an open configuration and a closed configuration is equivalent to transitioning the onboard recirculation system 206 between an open loop configuration and a closed loop configuration. The primary valve 210 may be manually opened/closed and/or the primary valve 210 may be automatically opened/closed in response to an event. For example, the primary valve 210 may automatically open when the system is coupled to a ground system. The primary valve 210 enables additional cooling fluid to flow into the onboard recirculation system 206 from an outside source such as a ground support equipment (GSE) port station 216 or the like, to be described in further detail below. The primary valve 210 may be a solenoid valve according to some embodiments. The onboard recirculation system 206 further includes a common fluid line 217 fluidly coupled to each of the plurality of battery modules 202 for distributing the cooling fluid to each of the plurality of battery modules 202. The common fluid line 217 may also return the fluid to the coolant source 208, according to some embodiments, such as via the return line 223. The two lines may circulate the cooling fluid through the battery pack 204 (or through a plurality of battery packs).

The onboard recirculation system 206 may include a coolant source 208, alternatively referred to herein as cooling fluid container. The coolant source 208 may be a coolant tank or the like. The coolant source 208 may store cooling fluid to be provided to the TR propagation mitigation system 200 when the onboard recirculation system 206 is in the closed loop configuration. The onboard recirculation system 206 may be further coupled to a pump 212 and the pump 212 may be further coupled to a check valve 214. According to some embodiments, the cooling fluid only flows from the coolant source 208 when the onboard recirculation system 206 is in the closed loop configuration.

The onboard recirculation system 206 (or components thereof) may be removably coupled to a ground support equipment (GSE) port station 216. The GSE port station 216 may include any support equipment found at an airport for servicing aircraft between flights. For example, a GSE port station 216 may include equipment for ground power operations, aircraft mobility, cargo/passenger loading operations, etc. The GSE port station 216 may include an inlet 218 and an outlet 220 which refer to coupling mechanisms between the TR propagation mitigation system 200 and the onboard recirculation system 206.

In various embodiments, the TR propagation mitigation system 200 is coupled to the inlet 218 of the GSE port station 216 for replenishing cooling fluid within the TR propagation mitigation system 200 and the onboard recirculation system 206. The GSE port station 216 is operable to flow additional cooling fluid to the TR propagation mitigation system 200. For example, cooling fluid may be lost during flight due to leaks or as steam as the cooling fluid is heated by the battery modules 202. According to various embodiments, the onboard recirculation system 206 is in the open loop configuration when cooling fluid flows from the inlet 218 of the GSE port station 216.

According to various embodiments, an open loop configuration may refer to a configuration where a device (such as an aerial vehicle) having the TR propagation mitigation system 200 is not in operation and receiving cooling fluid from the GSE port station 216. According to various embodiments, the onboard recirculation system 206 for TR heat distribution may be bypassed via the primary valve 210 to operate the TR propagation mitigation system 200 using external chillers (such as chillers as part of the GSE port station 216). For example, when the onboard recirculation system 206 is incorporated in an aircraft, the onboard recirculation system 206 may be bypassed during the ground charging operations of the aircraft. In contrast, a closed loop configuration as described herein may refer to a configuration where the device having the TR propagation mitigation system 200 is in operation and cooling fluid may be circulated through the onboard recirculation system 206.

According to various embodiments, each of the plurality of battery modules 202 includes a secondary valve 215. Each of the secondary valve 215 is operable to stop flow of the cooling fluid. In some embodiments, the TR propagation mitigation system 200 is configured to detect a thermal runaway event in at least one of the battery modules 202. A thermal runaway as used throughout the present disclosure may refer to a rapid, uncontrolled increase in temperature within a system caused by exothermic reactions that accelerate as the temperature rises, often resulting in fire, explosion, or catastrophic system failure. For example, the TR propagation mitigation system 200 is configured to detect a TR event in a TR module 202T as shown in FIG. 2A. In response to detecting the TR event, the secondary valve 215 associated with the TR module 202T transitions to a closed configuration that stops the flow of cooling fluid to the TR module 202T. This may isolate the TR module 202T, thereby preventing the TR event from spreading to other battery modules 202 such as neighbor battery modules 202N. Furthermore, stopping the cooling fluid from flowing to the TR module 202T may prevent leaking of cooling fluid through the damaged TR module 202T. In other embodiments, in response to detecting a TR event, the cooling fluid continues to flow to the TR module 202T and each of the other battery modules 202. In various embodiments, the TR propagation mitigation system 200 may be either in an always-on state to provide additional cooling benefits at the expense of higher power consumption or be triggered to only turn on if a TR condition is detected.

Embodiments of the present disclosure provide dual purposing the onboard recirculation system 206 as a means to actively redistribute heat from a TR module 202T away from its neighbors (e.g., neighboring battery module 202N) and into the bulk thermal mass of the entire battery system (e.g., the battery pack 204). Rather than raising the temperature of the neighbor module (e.g., neighboring battery module 202N) by a substantial and problematic amount, all battery modules 202 may be heated by a much smaller and acceptable amount. Since all battery modules 202 are cooled in parallel, this provides effective mixing of the hotter and cooler fluid during each loop to provide even temperature distribution away from the TR source.

The TR propagation mitigation system 200 may operate in a closed loop configuration 230 and/or in an open loop configuration 240. In the closed loop configuration 230, all components forming the TR propagation mitigation system 200 are rated to survive the extreme temperatures and keep a hermetic seal with no leaks. Coolant may be circulated through all the battery modules 202 to absorb heat from the hot spots and reject the heat into the thermal mass of the colder spots. Some embodiments may include a larger coolant tank, such as coolant source 208, that may be provided as a constant supply of coolant to the heat source (e.g., the battery pack 204). The latent heat of vaporization of the coolant absorbs energy from the battery pack 204 and may eject it from the TR propagation mitigation system 200 as steam through an exhaust system (not shown). Coolant circulating in the rest of the TR propagation mitigation system 200 may also help redistribute heat in a similar fashion as in the closed loop configuration 230.

According to various embodiments, the onboard recirculation system 206 for TR heat distribution may be bypassed via the primary valve 210 to operate external chillers during ground charging operations (such as chillers as part of the GSE port station 216). Powering the pump 212 and the primary valve 210 may simultaneously switch the TR propagation mitigation system 200 into its “TR mitigation” mode. In various embodiments, the onboard recirculation system 206 may be either an always-on matter to provide additional cooling benefits at the expense of higher power consumption or be triggered to only turn on if a TR condition is detected.

In some embodiments, a sensor 221 may be provided to that is configured to detect a change in temperature indicative of a thermal event and an end of a thermal event (e.g., a drop in temperature after an increase in temperature indicative of the thermal event). The sensor 221 may be further configured to detect a change in pressure, humidity, moisture, air flow, etc. One or more sensors may be provided for detecting the thermal runaway event.

FIG. 2B is a block diagram of the TR propagation mitigation system 200 having an onboard recirculation system 206 in a closed loop configuration. A closed loop configuration is an in-flight configuration when the TR propagation mitigation system 200 is implemented into an aerial vehicle or the like. In other embodiments, the closed loop configuration refers to an operating configuration where the system is not coupled to a ground support station or fuel/coolant replenishing station. The onboard recirculation system 206 includes a primary valve 210 for transitioning the onboard recirculation system 206 between a closed loop configuration and an open loop configuration. For example, transitioning the primary valve 210 between an open configuration and a closed configuration is equivalent to transitioning the onboard recirculation system 206 between an open loop configuration and a closed loop configuration. The primary valve 210 enables additional cooling fluid to flow into the onboard recirculation system 206 from an outside source such as a GSE port station 216 or the like.

FIG. 3 is a flow chart of a method of cooling a plurality of battery modules. Process 300 may include more or less operations than those described herein. Various embodiments of the present disclosure, such as operations of process 300, are performed by one or more processors such as the one or more processors 201 of FIGS. 2A-2B. As shown, the one or more processors 201 may be part of the onboard recirculation system 206. In other embodiments, the one or more processors 201 may be part of the TR propagation mitigation system 200 or a device including the TR propagation mitigation system 200, such as an aerial vehicle or the like. Process 300 may be applied to systems and devices described herein such as the TR propagation mitigation system 200 described with respect to FIGS. 2A-2B. Block 302 includes transitioning a primary valve between an open configuration and a closed configuration. According to various embodiments, transitioning the primary valve between an open configuration and a closed configuration is equivalent to transitioning the onboard recirculation system between an open loop configuration and a closed loop configuration. The primary valve enables additional cooling fluid to flow into the onboard recirculation system from an outside source such as a GSE port station or the like. The primary valve may be a solenoid valve according to some embodiments.

Block 304 includes distributing cooling fluid through a common fluid line to the plurality of battery modules in a battery pack when the primary valve is in the closed configuration. The common fluid line is fluidly coupled to each of the plurality of battery modules for distributing the cooling fluid to each of the plurality of battery modules. In some embodiments, the plurality of battery modules are coupled to the common fluid line in parallel.

According to some embodiments, cooling fluid is distributed through the common fluid line to the plurality of battery modules when the primary valve is in the closed configuration and when the primary valve is in the open configuration. For example, the common fluid line distributes supplementary cooling fluid to the plurality of battery modules to cool the plurality of battery modules when the system is coupled to a ground support station or the like. For example, when the system is implemented in an aerial vehicle, supplementary cooling fluid may be provided, via the common fluid line, to the plurality of battery modules to cool off the plurality of battery modules between flights. According to some embodiments, process 300 includes distributing supplementary cooling fluid through the common fluid line via a ground station port when the primary valve is in the open configuration.

Block 306 includes detecting a thermal runaway event in at least one of the plurality of battery modules. In some embodiments, a sensor may be provided to that is configured to detect a change in temperature indicative of a thermal event and an end of a thermal event (e.g., a drop in temperature after an increase in temperature indicative of the thermal event). The sensor may be further configured to detect a change in pressure, humidity, moisture, air flow, etc. One or more sensors may be provided for detecting the thermal runaway event. In various embodiments, the sensor may detect an increase in temperature and send the signal data to a processor, such as the one or more processors 201 of FIGS. 2A-2B, for performing various actions or causing the various actions to be performed.

Block 308 includes distributing additional cooling fluid from a cooling fluid container through the common fluid line to the plurality of battery modules. For example, additional cooling fluid flows from the cooling fluid container when the primary valve is in the closed configuration. Cooling fluid stored in the cooling fluid container may be constantly flowed through the common fluid line to the plurality of battery modules or the cooling fluid stored in the cooling fluid container may only be flowed through the common fluid line to the plurality of battery modules in response to detecting a thermal runaway event.

According to some embodiments, in response to detecting the thermal runaway event, block 308 may proceed to block 310 including closing a secondary valve coupled the at least one of the plurality of battery modules to stop flow of the cooling fluid. For example, each of the plurality of battery modules may be fluidly coupled to a secondary valve which is operable to stop flow to the respective battery module. In some embodiments, the secondary valve transitions from an open configuration to a closed configuration. In the closed configuration, cooling fluid does not flow to the respective battery module, thereby isolating the battery module and preventing the battery module from adding heat to the cooling fluid that would be transferred to the other plurality of battery modules. The secondary valve associated with a battery module experiencing a thermal event may be transitioned to the closed configuration in response to detecting a thermal runaway event.

In some embodiments, process 300 includes detecting an end of the thermal runaway event in the at least one of the plurality of battery modules via the sensor and stopping flow of the cooling fluid from the cooling fluid container through the common fluid line to the plurality of battery modules. For example, the sensor may detect that the thermal runaway is extinguished due to a drop in temperature. Accordingly, it may be more efficient to stop flow between the plurality of battery modules to reduce increasing the heat of the cooling fluid.

According to various embodiments, the TR propagation mitigation system may be tuned based at least in part on the application of the system (e.g., the device) and/or the user preferences. For example, the flow rate of the cooling fluid may be varied based on the thermal mass of the cooling fluid. A pump may be modified to flow the cooling fluid throughout the system as varying speeds depending on whether a thermal runaway is detected, in some embodiments.

### Examples

Example 1: A thermal runaway (TR) propagation mitigation system includes a plurality of battery modules and an onboard recirculation system coupled to the plurality of battery modules. The onboard recirculation system includes a primary valve for transitioning the onboard recirculation system between a closed loop configuration and an open loop configuration, a cooling fluid container storing cooling fluid provided to the TR propagation mitigation system when the onboard recirculation system is in the closed loop configuration, and a pump for flowing the cooling fluid through the TR propagation mitigation system when the onboard recirculation system is in the closed loop configuration.

Example 2: A system according to example 1, further including a ground station port operable to flow additional cooling fluid through the TR propagation mitigation system when the onboard recirculation system is in the open loop configuration.

Example 3: A system according to any of examples 1-2, where each of the plurality of battery modules includes a secondary valve and where each of the secondary valves is operable to stop flow of the cooling fluid to, in response to a thermal runaway event in a respective battery module.

Example 4: A system according to any of examples 1-3, where the plurality of battery modules are coupled to the TR propagation mitigation system in parallel.

Example 5: A system according to any of examples 1-4, where the cooling fluid only flows from the cooling fluid container when the onboard recirculation system is in the closed loop configuration.

Example 6: A system according to any of examples 1-5, where the onboard recirculation system further comprises a common fluid line fluidly coupled to each of the plurality of battery modules for distributing the cooling fluid to each of the plurality of battery modules.

Example 7: A system according to any of examples 1-6, further including a sensor configured to detect a change in temperature indicative of a thermal runaway event in at least one battery module of the plurality of battery modules.

Example 8: A system according to any of examples 1-7, where the primary valve is a solenoid valve.

Example 9: An aerial vehicle including one or more of the TR propagation mitigation system of any of examples 1-8.

Example 10: The aerial vehicle according to example 9, where the aerial vehicle is an eVTOL vehicle.

Example 11: A method of cooling a plurality of battery modules including transitioning a primary valve between an open configuration and a closed configuration, distributing cooling fluid through a common fluid line to the plurality of battery modules in a battery pack when the primary valve is in the closed configuration, and detecting a thermal runaway event in at least one of the plurality of battery modules. The method further includes distributing additional cooling fluid from a cooling fluid container through the common fluid line to the plurality of battery modules.

Example 12: A method according to example 11, further including distributing supplementary cooling fluid through the common fluid line via a ground station port when the primary valve is in the open configuration.

Example 13: A method according to any of examples 11-12, further including, in response to detecting the thermal runaway event, closing a secondary valve coupled the at least one of the plurality of battery modules to stop flow of the cooling fluid.

Example 14: A method according to any of examples 11-13, where the additional cooling fluid flows from the cooling fluid container when the primary valve is in the closed configuration.

Example 15: A method according to any of examples 11-14, where the plurality of battery modules are coupled to the common fluid line in parallel.

Example 16: A method according to any of examples 11-15, where the battery pack is installed in an aerial vehicle.

Example 17: A method according to any of examples 11-16, where the aerial vehicle is an eVTOL vehicle.

Example 18: A method according to any of examples 11-17, where the primary valve is a solenoid valve.

Example 19: A method according to any of examples 11-18, further including detecting the thermal runaway event in the at least one of the plurality of battery modules via a sensor configured to detect a change in temperature indicative of the thermal runaway event.

Example 20: A method according to any of examples 11-19, further including detecting an end of the thermal runaway event in the at least one of the plurality of battery modules via the sensor and stopping flow of the cooling fluid from the cooling fluid container through the common fluid line to the plurality of battery modules, in response to the end of the thermal runaway event.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

Upon reading this disclosure, those of skill in the art will appreciate still additional alternative designs for the system. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in any claims drawn to the subject matter herein.

What is claimed is:

1. A thermal runaway (TR) propagation mitigation system comprising:
a plurality of battery modules; and
an onboard recirculation system coupled to the plurality of battery modules, the onboard recirculation system comprising:
a primary valve for transitioning the onboard recirculation system between a closed loop configuration and an open loop configuration,
a cooling fluid container storing cooling fluid provided to the TR propagation mitigation system when the onboard recirculation system is in the closed loop configuration; and
a pump for flowing the cooling fluid through the TR propagation mitigation system when the onboard recirculation system is in the closed loop configuration.

2. The system of claim 1, further comprising a ground station port operable to flow additional cooling fluid through the TR propagation mitigation system when the onboard recirculation system is in the open loop configuration.

3. The system of claim 1, wherein each of the plurality of battery modules comprises a secondary valve, wherein each of the secondary valves is operable to stop flow of the cooling fluid to, in response to a thermal runaway event in, a respective battery module.

4. The system of claim 1, wherein the plurality of battery modules are coupled to the TR propagation mitigation system in parallel.

5. The system of claim 1, wherein the cooling fluid only flows from the cooling fluid container when the onboard recirculation system is in the closed loop configuration.

6. The system of claim 1, wherein the onboard recirculation system further comprises a common fluid line fluidly coupled to each of the plurality of battery modules for distributing the cooling fluid to each of the plurality of battery modules.

7. The system of claim 1, wherein the onboard recirculation system further comprises a return line, wherein the distributed cooling fluid is recirculated after being mixed with new cooling fluid from the cooling fluid container.

8. The system of claim 1, further comprising a sensor configured to detect a change in temperature indicative of a thermal runaway event in at least one battery module of the plurality of battery modules.

9. The system of claim 1, wherein the primary valve is a solenoid valve.

10. An aerial vehicle comprising one or more of the TR propagation mitigation system of claim 1.

11. A method of cooling a plurality of battery modules, the method comprising:
transitioning a primary valve between an open configuration and a closed configuration;
distributing cooling fluid through a common fluid line to the plurality of battery modules in a battery pack when the primary valve is in the closed configuration; and
detecting a thermal runaway event in at least one of the plurality of battery modules; and
distributing additional cooling fluid from a cooling fluid container through the common fluid line to the plurality of battery modules.

12. The method of claim 11, comprising distributing supplementary cooling fluid through the common fluid line via a ground station port when the primary valve is in the open configuration.

13. The method of claim 11, comprising, in response to detecting the thermal runaway event, closing a secondary valve coupled the at least one of the plurality of battery modules to stop flow of the cooling fluid.

14. The method of claim 11, wherein the additional cooling fluid flows from the cooling fluid container when the primary valve is in the closed configuration.

15. The method of claim 11, wherein the plurality of battery modules are coupled to the common fluid line in parallel.

16. The method of claim 11, wherein the battery pack is installed in an aerial vehicle.

17. The method of claim 16, wherein the aerial vehicle is an eVTOL vehicle.

18. The method of claim 16, wherein the primary valve is a solenoid valve.

19. The method of claim 11, further comprising detecting the thermal runaway event in the at least one of the plurality of battery modules via a sensor configured to detect a change in temperature indicative of the thermal runaway event.

20. The method of claim 19, further comprising:
detecting an end of the thermal runaway event in the at least one of the plurality of battery modules via the sensor; and
stopping flow of the cooling fluid from the cooling fluid container through the common fluid line to the plurality of battery modules, in response to the end of the thermal runaway event.
